(19) United States
(12) Patent Application Publication
(10) Pub. No.: US 2010/0017293 A1
(43) Pub. Date: Jan. 21, 2010

(54) System, method, and computer program for providing multilingual text advertisments

(75) Inventors: Felix Lung, Los Angeles, CA (US); William Wong, Huntington Beach, CA (US)

Correspondence Address: CARR & FERRELL LLP, 2200 GENG ROAD, PALO ALTO, CA, 94303, US

(73) Assignee: Language Weaver, Inc.

(21) Appl. No.: 12/218,859

(22) Filed: Jul. 17, 2008

(51) Int. Cl. G06Q 30/00

(52) U.S. Cl. 705/14.55

(57) ABSTRACT

A system, method, and computer program for providing multilingual text advertisements is provided. An advertisement is received in a source language. One or more target languages to associate with the advertisement are specified. At least one landing page associated with the advertisement is identified based on the one or more target languages. A user is then directed to the at least one landing page when the advertisement is accessed by the user.

### BACKGROUND

1. Field of the Invention

The present invention relates generally to online advertising, and more particularly to a system, method, and computer program for providing multilingual text advertisements.

2. Background Art

Conventionally, traditional Internet advertising is divided into two camps comprising advertisers and publishers. Publishers are individuals or organizations that own or represent websites which have available space or inventory that can be sold to advertisers. Advertisers are individuals or organizations looking to promote products, services, or brands on available space on a publisher's website. Over the years, Internet advertising has evolved from delivering simple graphical banner advertisements to delivering targeted advertisements based on various criteria (e.g., geo-targeting, keyword targeting, user targeting). These targeted advertisements include text advertisements and rich-media advertisements.

One of the more successful advertising models to flourish over the last several years has been a text advertisement model popularized by Yahoo!™ and Google™. A text advertisement consists of a simple headline, some product description, and a “click-through” URL link that redirects the user to an advertiser's website. Text advertisements have become quite popular because they are relatively unobtrusive, are easily integrated into a publisher's website, and produce above-average industry click-through rates (i.e., number of clicks/number of advertisements delivered).

### SUMMARY OF THE INVENTION

A system, method, and computer program for providing multilingual text advertisements is provided. An advertisement is received in a source language. One or more target languages to associate with the advertisement are specified. At least one landing page associated with the advertisement is identified based on the one or more target languages. A user is then directed to the at least one landing page when the advertisement is accessed by the user.

### BRIEF DESCRIPTION OF THE DRAWINGS

FIG. 1 is a block diagram illustrating an exemplary environment for providing multilingual text advertisements.

FIG. 2 is a block diagram illustrating an exemplary multilingual engine.

FIG. 3 is a block diagram illustrating an exemplary multilingual text advertisement broker.

FIG. 4 is a flow diagram illustrating an exemplary process for providing multilingual text advertisements.

FIG. 5 is a block diagram illustrating an exemplary infrastructure through which a user interacts with a text advertisement.

### DESCRIPTION OF EXEMPLARY EMBODIMENTS

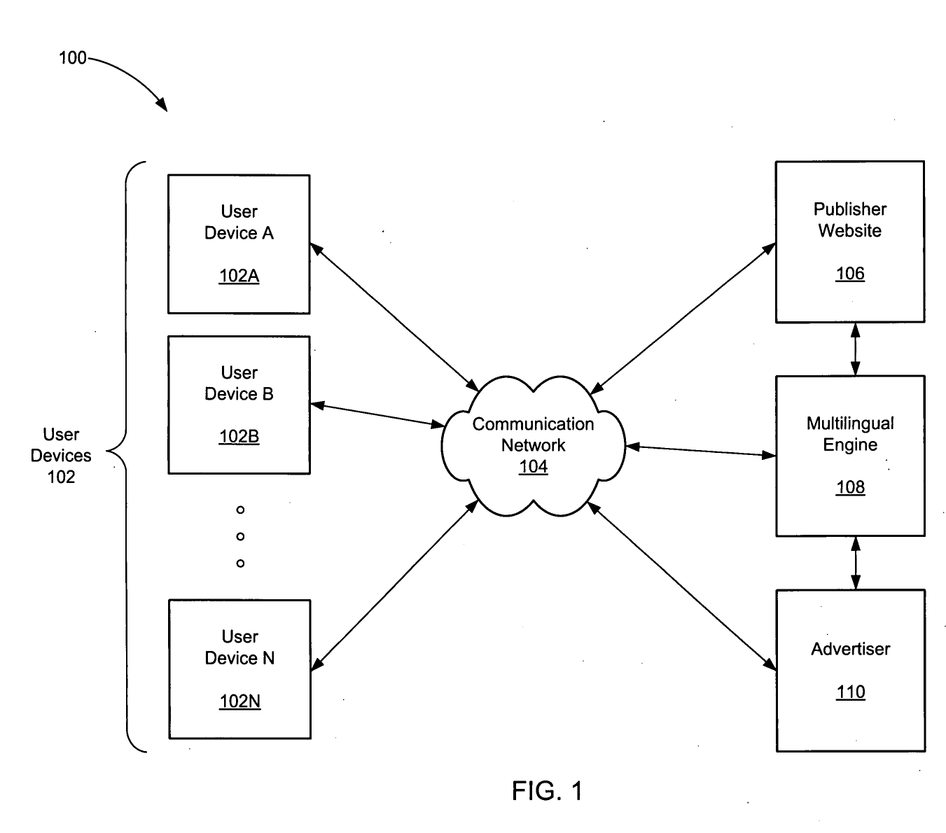

FIG. 1 is a block diagram illustrating an exemplary environment 100 for providing multilingual text advertisements. One or more user devices 102 (e.g., a user device A 102A, a user device B 102B, or a user device N 102N) are in communication via a communication network 104 with a publisher website 106 and a multilingual engine 108. The publisher website 106 communicates with the multilingual engine 108 and/or an advertiser 110. The user devices 102 may be associated with one or more users. The multilingual engine 108 may be associated with a language translation entity.

The user devices 102 may include any type of devices that have access to the communication network 104, which may comprise a wide area network or any other type of network. For example, the user devices 102 may comprise a computing device, a laptop or desktop computer, a cellular telephone, a personal digital assistant (PDA), and so forth.

The publisher website 106 may be any website that displays, or otherwise presents, advertisements. Furthermore, the advertisements website 106 may be associated with any person or entity. For example, a publisher associated with the publisher website 106 may sell advertising space to the advertiser 110. According to exemplary embodiments, a person or entity associated with the multilingual engine 108 charges a fee for translation services associated with the advertisements and/or landing pages associated with the publisher website 106 and the advertiser 110.

The advertiser 110 may communicate with the multilingual engine 108 directly and/or via the communication network 104. In some embodiments, the advertiser 110 may utilize the multilingual engine 108 to submit advertisements to be displayed, or otherwise accessed, via the publisher website 106. Subsequently, one or more users associated with the user devices 102 may access the advertisements via the publisher website 106. When users access the advertisements, the multilingual engine 108 may direct the users to one or more landing pages, such as a landing page associated with the advertiser 110.

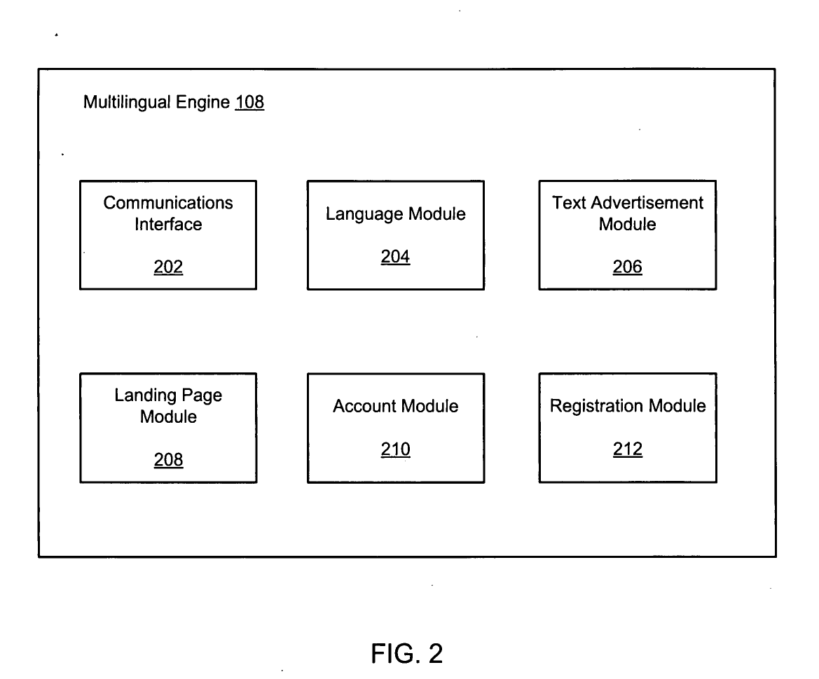

FIG. 2 is a block diagram illustrating the exemplary multilingual engine 108. In exemplary embodiments, the multilingual engine 108 comprises a communications interface 202, a language module 204, a text advertisement module 206, a landing page module 208, an account module 210, and a registration module 212. Although various modules are described in association with FIG. 2, fewer or more modules may comprise the multilingual engine 108 and still fall within the scope of various embodiments. Furthermore, the functions of the various modules may be combined within fewer modules and still be within the scope of exemplary embodiments.

The exemplary communications interface module 202 is configured to facilitate communications between the multilingual engine 108 with the user devices 102, the publisher website 106, and/or the advertiser 110. For example, the multilingual engine 108 may receive advertisements directly from the advertiser 110 via the communication network 104, as discussed herein.

The language module 204 receives, via the communications interface 202 and the text advertisement module 206, advertisement requests from the advertiser 110. The advertisement requests may comprise any form of communication from the advertiser 110 indicating a specific advertisement to be presented by the publisher website 106. The language module 204 further receives one or more target languages to which the advertisement should be translated. In exemplary embodiments, the language module 204 also translates text associated with the publisher website 106 and/or the landing pages associated with the advertiser 110.

The text advertisement module 206 receives one or more advertisements, along with data associated with the advertisements, from the advertiser 110 in a source language. In some embodiments, the text advertisement module 206 may utilize the target language information from the language module 204 to translate the one or more advertisements from the advertiser 110 into the desired target languages.

The landing page module 208 generates one or more landing pages to associate with the advertisements submitted by the advertiser 110. The landing pages may be stored or generated on the fly, in accordance with various embodiments. The landing pages may utilize target language information from the language module 204 to generate the landing pages. For example, if the advertiser 110 specifies Chinese and French as target languages to associate with the submitted advertisements, the landing pages may be generated in both Chinese and French. If the user accesses the Chinese advertisement via the publisher website 106, the user will be directed to a Chinese version of the landing page, while the user accessing the French advertisement via the publisher website 106 may be directed to a French version of the landing page. It should be noted that the publisher website 106 may be in any language. For example, Chinese and French advertisements may both be accessed via the publisher website 106 or the Chinese and the French advertisements may be accessed via language specific versions of the publisher website 106.

The landing page module 208 may also direct the user to the one or more landing pages when the advertisement associated with the publisher website 106 is accessed. The landing page module 208 may utilize the data from the text advertisement module 206 in order to direct the user to the landing page or any other information from any other module.

The account module 210 tracks fees associated with the text advertisements. For example, the advertiser 110 may pay a provider of the publisher website 106 a fee in order to place advertisements on the publisher website 106. An owner of the multilingual engine 108 may charge a fee to the advertiser 110 and/or the publisher of the publisher website 106 in order to direct users to landing pages in the one or more target languages identified by the advertiser 110. The account module 210 may track one or more of the fees associated with a relationship between the provider of the publisher website 106, the owner of the multilingual engine 108, and/or the advertiser 110.

A registration module 212 receives registration information from the publisher. In exemplary embodiments, the publisher provides a list of websites that the publisher owns and/or maintains. Various data about the websites may also be provided, such as a category of the website, keyword descriptions of the website, language associated with the website, and how much the publisher is willing to sell space to the advertiser 110. In one embodiment, bidding may take place by various advertisers (e.g., the advertiser 110), such that the various advertisers may obtain available space on websites owned or represented by the publishers. The data provided about the publisher and/or the websites associated with the publisher (e.g., the publisher website 106) may be stored in volatile and/or non-volatile memory that is accessible to the multilingual engine 108.

Based on the data provided via a registration process and traffic statistics from the publisher website 106, the registration module 212 may determine whether the publisher website 106 is approved for participation in a multilingual advertising service provided by the multilingual engine 108. For example, one or more parameters, such as Internet rankings, may be established by the registration module 212. If the publisher provides data that meets the parameters, the publisher website 106 may be automatically approved for participation in the multilingual advertising service. According to alternative embodiments, the publisher website 106 is manually approved based on the data provided by the publisher.

Once the publisher website 106 is approved for participation in the multilingual advertising service, text associated with the publisher website 106 is translated by the language module 204. For example, the language module 204 may translate a description, keyword descriptions, or other text associated with the publisher website 106 into one or more target languages identified by the publisher associated with the publisher website 106.

The language module 204 may also provide the publisher associated with the publisher website 106 with information in order to communicate with the multilingual engine 108. For example, the language module 204 may provide a piece of code for the publisher to embed in the publisher website 106. The piece of code is then executed on a web browser associated with the one or more users (e.g., the one or more users associated with the user devices 102). Based on the piece of code, the multilingual engine 108 is queried for advertisements from a browser on the user's device (e.g., the user devices 102) to embed in the publisher website 106.

According to exemplary embodiments, the advertiser 110 purchases space on the publisher website 106 for a specified period of time. When the user clicks on or otherwise accesses the advertisement on the publisher website 106, the “click” is communicated to the multilingual engine 108. In some embodiments, the multilingual engine 108 registers and records the clicks. Based on the advertisement accessed by the user, the user is directed to the landing page associated with the specific advertisement (e.g., the landing page associated with the advertiser 110 that purchased the advertisement space on the publisher website 106). The landing page may be hosted by the advertiser 110 or a party that owns and/or controls the multilingual engine 108.

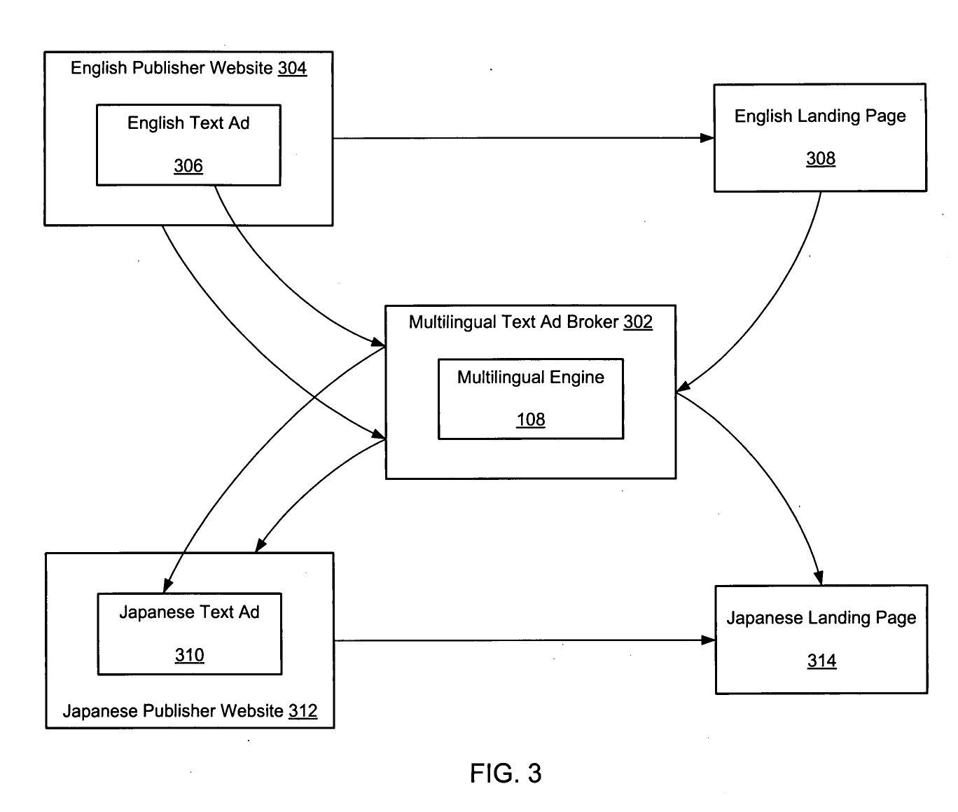

Referring now to FIG. 3, a block diagram illustrating an exemplary multilingual text advertisement broker 302 in communication with various websites and landing pages (e.g., an English publisher website 304, an English landing page 308, a Japanese publisher website 312, and a Japanese landing page 314) is shown. According to various embodiments, the multilingual text advertisement broker 302 may coordinate and/or control various exchanges (e.g., financial transactions and data transfers) between the user devices 102, websites (e.g., the publisher website 106), advertisers (e.g., the advertiser 110), and other parties. As depicted, the multilingual text advertisement broker 302 comprises the multilingual engine 108. However, in some embodiments, the multilingual text advertisement broker 302 may be in communication with the multilingual engine 108, for example, via the communication network 404. In the present embodiment, the multilingual text advertisement broker 302 is depicted as operating between a first language and a second language. However, in other exemplary embodiments, the multilingual text advertisement broker 302 may operate between pluralities of languages. The first language and the second language may be any language, but for descriptive purposes, the first language is depicted as English and the second language is depicted as Japanese.

According to various embodiments, the multilingual text advertisement broker 302 may facilitate an interaction between a number of English publishers and a number of advertisers. This interaction may comprise a bidding or auction format as well as other formats for exchange of monies, goods, and/or services as is known by those skilled in the art. In one embodiment, the multilingual engine 108 may facilitate bidding by various advertisers (e.g., the advertiser 110) with various publishers, such that the various advertisers may obtain available space on websites owned or represented by the publishers.

In one example, an English publisher website 304 may comprise an English text advertisement 306. The advertiser 110, to whom the English text advertisement 306 belongs, may wish to advertise to a Japanese-speaking audience. Accordingly, the multilingual text advertisement broker 302 may receive the English text advertisement 306, an English landing page 308, contents from the English publisher website 304 and/or links thereto, from the publisher of the English publisher website 304.

Subsequently, the multilingual text advertisement broker 302 may output a Japanese text advertisement 310, which is a translated version of the English text advertisement 306, to be placed on a Japanese publisher website 312. This translation may be performed, for example, by the language module 204. In one embodiment, the multilingual text advertisement broker 302 may output a translation of the English publisher website 304. In such a case, the Japanese publisher website 312, as depicted, may be replaced by the translation of the English publisher website 304. The translation of the English publisher website 304 may be hosted by a Japanese publisher or any other party (e.g., the party that owns and/or controls the multilingual text advertisement broker 302).

In some embodiments, the Japanese landing page 314 may be translated from the English landing page 308 by the multilingual advertisement broker 302. In addition, the Japanese landing page 314 may be hosted by a Japanese advertiser or any other party (e.g., the party that owns and/or controls the multilingual text advertisement broker 302).

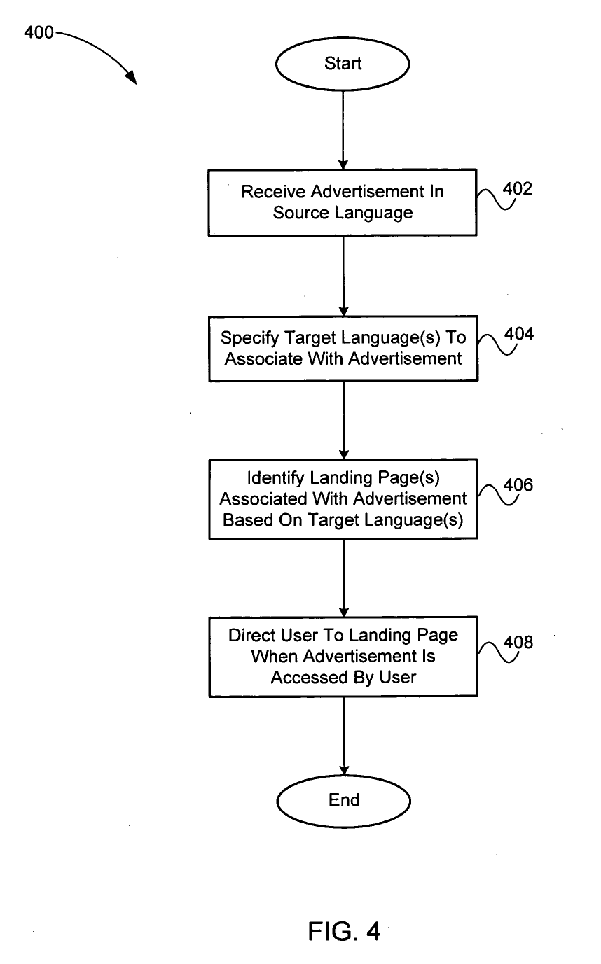

FIG. 4 is a flow diagram illustrating an exemplary process 400 for providing multilingual text advertisements. According to various embodiments, the process 400 may be carried out by the multilingual engine 108, the multilingual text advertisement broker 302, or any combination thereof.

In step 402, an advertisement is received in the source language. According to exemplary embodiments, the text advertisement module 206 may receive the advertisement. The advertisement may be received from a publisher (e.g., the English publisher website 304 and the Japanese publisher website 312) and/or the advertiser 110. As mentioned, in some embodiments, the text advertisement module 206 may utilize the target language information from the language module 204 to translate the one or more advertisements from the advertiser 110 into the desired target languages.

In step 404, one or more target languages are specified to associate with the advertisement. The language module 204 may specify the one or more languages in exemplary embodiments. In one example, the language module 204 may receive an advertisement request from the advertiser 110, which may specify the one or more languages to associate with the advertisement.

In step 406, at least one landing page associated with the advertisement is identified base on the one or more target languages. According to exemplary embodiments, the landing page module 208 may perform step 406. In one embodiment, the at least one landing page is generated on behalf of a provider of the advertisement (e.g., the advertiser 110) based on the one or more target languages. In another embodiment, the landing page comprises a website associated with the provider of the advertisement. In addition, the website associated with the provider of the advertisement may be automatically translated based on the one or more target languages. In some embodiments, the number of landing pages identified is smaller than the number of target languages identified. Additionally, the at least one landing page may be ranked in order to determine quality. Furthermore, the provider of the advertisement may be matched with an owner associated with the at least one landing page based on the one or more target languages, in accordance with various embodiments.

In step 408, a user is directed to the at least one landing page when the advertisement is accessed by the user. The landing page module 208 may also perform step 408 in exemplary embodiments. In one embodiment, the advertisement is accessed by the user via the website associated with the publisher. In turn, the publisher may also collect a fee for associating the advertisement with the website, in some embodiments. Additionally or alternatively, a fee may be charged for directing the user to the at least one landing page.

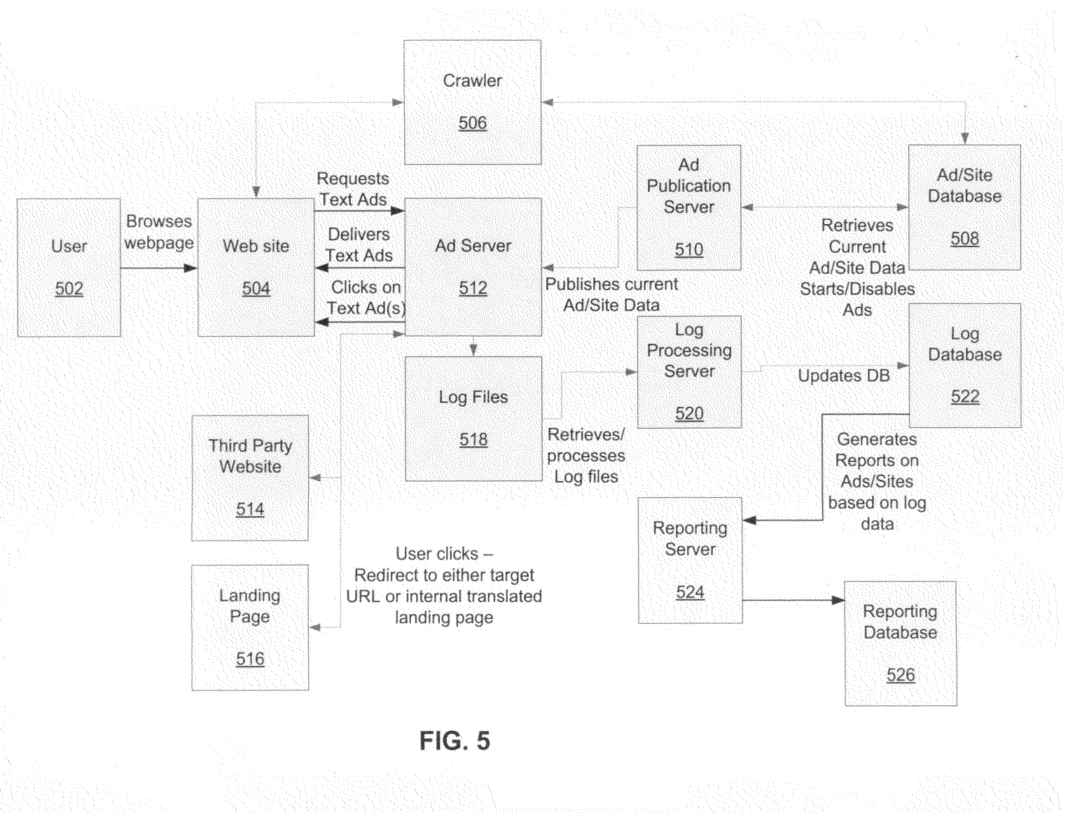

FIG. 5 is a block diagram illustrating an exemplary infrastructure 500 through which a user 502 interacts with the text advertisement. Although the infrastructure 500 is depicted as comprising various components, the infrastructure 500 is exemplary and may comprise more components or less components and still fall within the scope of various embodiments. Additionally, those skilled in the art will recognize that some of the components may be combined.

In the infrastructure 500, the user 502 may browse a website 504. In the meantime, a crawler 506 (e.g., a program or automated script) may be gathering, categorizing, and/or otherwise obtaining information on the communication network 104 (e.g., the Internet), particularly the information pertaining to the website 504. The information obtained by the crawler 506 may comprise multilingual information from websites of many different languages. The crawler 506 may be in communication with an advertisement/site database 508, for example, via the communication network 104. The advertisement/site database 508 may store advertisement/site data, which comprises advertisements and the information obtained by the crawler 506.

An advertisement publication server 510 may receive current advertisement/site data from the advertisement/site database 508. The advertisement/site publication server 510 may also determine which advertisements are appropriate for various websites (e.g., the website 504) and/or various users (e.g., the user 502). Furthermore, the advertisement publication server 510 may use the current advertisement/site data to start and/or disable certain advertisements. The advertisement publication server 510 may publish the current advertisement/site data, which may, in turn, be received by an advertisement server 512. In exemplary embodiments, the advertisement server 512 may comprise the multilingual engine 108 and/or the multilingual advertisement broker 302.

While the user 502 browses the website 504, the website 504 may return code (e.g., HTML) to the user's browser, which may include code to retrieve advertisements from the advertisement server 512. In one example, the user's browser may request text advertisements from the advertisement server 512. The text advertisements may be related to the advertisement/site data. In response to the request, the advertisement server 512 may deliver the text advertisements to the website 504. The user 502 may then click on the texts advertisements presented by the website 504.

In response to the user 502 clicking on the text advertisement, the user's browser may be redirected to either a third party website 514 (or target URL) or a landing page 516. The landing page 516 may be internally translated, for example, by the multilingual engine 108. Additionally, the landing page 516 may be hosted by a party that owns and/or controls the advertisement server 512.

Also in response to the user 502 clicking on the text advertisement, the advertisement server 512 may generate log files 518. The log file 518 may comprise records of relationships between various users (e.g., the user 502), text advertisements, and websites (e.g., the website 504). A log processing server 520 may retrieve and process the log files 518 from the advertisement server 512. In turn, the log processing server 520 may update a log database 522 with log data comprising the log files 518. Reports on text advertisements and websites may be generated based on the log data, and received by a reporting server 524. The reporting server 524 may be in communication with a reporting database 526 that stores the reports.

The reports stored by the reporting database 526 may be utilized by many elements of the infrastructure 500. For example, the account module 210 may use the reports to track fees associated with the text advertisements. In another example, the advertisement publication server 510 may determine which advertisements and websites should be matched together, in part based on the reports. In addition, the advertisement publication server 510 may use the reports in starting and disabling certain advertisements, in some embodiments.

In an illustrative example of the infrastructure 500 in practice, the user 502 may be Japanese. The text advertisement presented on the webpage 504 may have originated from an English-language advertiser, but has been translated to Japanese at the advertisement server 512 by the multilingual engine 108. The English-language advertiser may wish to direct the user to an English-language website (e.g., the English publisher website 504). In order to present the English-language website to the user 502, such that the user 502 may easily and appropriately comprehend content of the English-language website, the multilingual engine 108 may translate the English-language website to a Japanese version. In one embodiment, the Japanese version of the English-language website may be hosted by a party different from that which hosts the English-language website (e.g., the party that owns and/or controls the multilingual engine 108). The reporting database 526 may comprise data detailing the abovementioned exchanges in order to properly distribute fees.

The above-described components and functions can be comprised of instructions that are stored on a computer-readable storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

While various embodiments have been described above, it should be understood that they have been presented by way of example only, and not limitation. For example, any of the elements associated with the multilingual server 106 may employ any of the desired functionality set forth hereinabove. Thus, the breadth and scope of a preferred embodiment should not be limited by any of the above-described exemplary embodiments.

What is claimed is:

1. A method comprising:
receiving an advertisement in a source language;
specifying one or more target languages to associate with the advertisement;
identifying at least one landing page associated with the advertisement based on the one or more target languages; and
directing a user to the at least one landing page when the advertisement is accessed by the user.

2. The method of claim 1, wherein the landing page comprises a website associated with a provider of the advertisement.

3. The method of claim 2, further comprising automatically translating the website based on the one or more target languages.

4. The method of claim 1, wherein the advertisement is accessed by the user via a website associated with a publisher.

5. The method of claim 4, wherein the publisher collects a fee for associating the advertisement with the website.

6. The method of claim 1, further comprising generating the at least one landing page on behalf of a provider of the advertisement based on the one or more target languages.

7. The method of claim 1, wherein a quantity of the at least one landing page is smaller than a quantity of the one or more target languages identified.

8. The method of claim 1, further comprising charging a fee for directing the user to the at least one landing page.

9. The method of claim 1, further comprising ranking the at least one landing page in order to determine quality.

10. The method of claim 1, further comprising matching a provider of the advertisement with an owner associated with the at least one landing page based on the one or more target languages.

11. A computer readable medium having embodied thereon a program, the program being executable by a processor for performing a method, the method comprising:
receiving an advertisement in a source language;
specifying one or more target languages to associate with the advertisement;
identifying at least one landing page associated with the advertisement based on the one or more target languages; and
directing a user to the at least one landing page when the advertisement is accessed by the user.

12. The computer readable medium of claim 11, wherein the landing page comprises a website associated with a provider of the advertisement.

13. The computer readable medium of claim 12, further comprising automatically translating the website based on the one or more target languages.

14. The computer readable medium of claim 11, wherein the advertisement is accessed by the user via a website associated with a publisher.

15. The computer readable medium of claim 14, wherein the publisher collects a fee for associating the advertisement with the website.

16. The computer readable medium of claim 11, further comprising generating the at least one landing page on behalf of a provider of the advertisement based on the one or more target languages.

17. The computer readable medium of claim 11, wherein a quantity of the at least one landing page is smaller than a quantity of the one or more target languages identified.

18. The computer readable medium of claim 11, further comprising charging a fee for directing the user to the at least one landing page.

19. The computer readable medium of claim 11, further comprising ranking the at least one landing page in order to determine quality.

20. The computer readable medium of claim 11, further comprising matching a provider of the advertisement with an owner associated with the at least one landing page based on the one or more target languages.

21. A system comprising:
a text advertisement module configured to receive an advertisement in a source language;
a language module, in communication with the text advertisement module, the language module configured to specify one or more target languages to associate with the advertisement;
a landing page module, in communication with the language module, the landing module configured to identify at least one landing page associated with the advertisement based on the one or more target language and to direct a user to the at least one landing page when the advertisement is accessed by the user.

22. The system of claim 21, wherein the landing page comprises a website associated with a provider of the advertisement.

23. The system of claim 22, wherein the language module is further configured to translate the website based on the one or more target languages.

24. The system of claim 21, wherein the advertisement is accessed by the user via a website associated with a publisher.

25. The system of claim 24, wherein the publisher collects a fee for associating the advertisement with the website.

26. The system of claim 21, wherein the landing page module is further configured to generate the at least one landing page on behalf of a provider of the advertisement based on the one or more target languages.

27. The system of claim 21, wherein a quantity of the at least one landing page is smaller than a quantity of the one or more target languages identified.

28. The system of claim 21, further comprising an account module configured to charge a fee for directing the user to the at least one landing page.

29. The system of claim 21, further comprising a registration module configured to rank the at least one landing page in order to determine quality.

30. The system of claim 21, a provider of the advertisement is matched with an owner associated with the at least one landing page based on the one or more target languages.
